(19) United States
(12) Patent Application Publication
(10) Pub. No.: US 2015/0337664 A1
(43) Pub. Date: Nov. 26, 2015

(54) TURBOMACHINE BLADE, CORRESPONDING TURBOMACHINE AND METHOD OF MANUFACTURING A TURBINE BLADE

(71) Applicant: NUOVO PIGNONE SRL, Florence (IT)

(72) Inventors: Lorenzo COSI, Florence (IT); Mirco INNOCENTI, Florence (IT); Francesco PIRACCINI, Florence (IT); Iacopo GIOVANNETTI, Florence (IT); Pierluigi TOZZI, Florence (IT)

(21) Appl. No.: 14/651,893

(22) PCT Filed: Dec. 11, 2013
(86) PCT No.: PCT/EP2013/076294

§ 371 Date: Jun. 12, 2015

(30) Foreign Application Priority Data
Dec. 13, 2012 (IT) CO2012A000059

(51) Int. Cl. F01D 5/14; B23P 15/02; F01D 9/02; F01D 5/18

(52) U.S. Cl. CPC F01D 5/141; F01D 5/18; B23P 15/02; F01D 9/02

(57) ABSTRACT

A blade of a turbomachine comprises an airfoil portion; the airfoil portion extends longitudinally; the airfoil portion is defined laterally by an external surface; the airfoil portion has a 3D and twisted shape and has an internal cavity; the blade is in a single piece. Furthermore, the blade is designed for a rotor or stator array; the rotor or stator defines a radial direction and an axial direction; the external surface of the airfoil portion has a leading edge and a trailing edge; the leading edge and/or the trailing edge shifts backward or forward in the axial direction moving in the radial direction; the internal cavity extends along substantially the whole longitudinal length of the airfoil portion. Additive manufacturing is particularly effective and advantageous for such blade.

### CROSS-REFERENCE TO RELATED APPLICATIONS

This is a national stage application under 35 U.S.C. § 371(c) of prior-filed, co-pending, PCT application serial number PCT/EP2013/076294, filed on Dec. 11, 2013, which claims priority to Italian Patent Application Ser. No. CO2012A000059 filed on Dec. 13, 2012 and titled METHODS OF MANUFACTURING 3D-SHAPED HOLLOW BLADES OF TURBOMACHINES BY ADDITIVE MANUFACTURING, TURBOMACHINE HOLLOW BLADES AND TURBOMACHINES. All of the above listed applications are herein incorporated by reference.

### BACKGROUND

Embodiments of the subject matter disclosed herein generally relate to methods of manufacturing turbomachines blades, turbomachines single-piece hollow blades so manufactured and turbomachines using such blades.

In the field of “Oil & Gas”, there is always a search for improved solutions for turbomachine blades.

Improvements may relate not only to functional aspects, for example the shape and size of the airfoil portion of the blade, but also to mounting, maintenance and especially manufacturing of the blade.

As far as manufacturing is concerned, it must be considered that in the field of “Oil & Gas” small-lot production is common also because solutions are sometimes studied (or at least customized) for a specific client.

### SUMMARY OF THE INVENTION

Therefore, there is a general need for improving the blades of turbomachines at least in terms of manufacturing.

What is ideal is to have high performance and low production cost.

An important consideration for the present invention is that the manufacturing method may be positively influence by the specific configuration of the blade to be manufactured.

A first aspect of the present invention is a blade of a turbomachine.

According to embodiments thereof, a blade of a turbomachine comprises an airfoil portion; the airfoil portion extends longitudinally; the airfoil portion is defined laterally by an external surface; the airfoil portion has a 3D and twisted shape and has an internal cavity; the blade is in a single piece. Furthermore, the blade is designed for a rotor or stator array; the rotor or stator defines a radial direction and an axial direction; the external surface of the airfoil portion has a leading edge and a trailing edge; the leading edge and/or the trailing edge shifts backward or forward in the axial direction moving in the radial direction; the internal cavity extends along substantially the whole longitudinal length of the airfoil portion.

In this case, additive manufacturing is particularly effective and advantageous.

A second aspect of the present invention is a turbomachine.

According to embodiments thereof, a turbomachine comprises a plurality of blades arranged as a rotor or stator array of a turbomachine stage; the blade has the features set out above.

A third aspect of the present invention is a method of manufacturing a turbomachine blade.

According to embodiments thereof, a method of manufacturing a turbomachine blade in a single piece uses additive manufacturing; the turbomachine blade has the features set out above.

Technical features of the blade, the turbomachine and the manufacturing method are set out in the detailed description.

### BRIEF DESCRIPTION OF DRAWINGS

The accompanying drawings, which are incorporated herein and constitute a part of the specification, illustrate embodiments of the present invention and, together with the description, explain these embodiments. In the drawings:

FIG. 1 shows very schematically a side view of a rectilinear hollow blade of a turbomachine,

FIG. 2 shows very schematically a side view of a rectilinear twisted hollow blade of a turbomachine,

FIG. 3 shows very schematically a side view of a first 3d-shaped hollow blade of a turbomachine according to the present invention,

FIG. 4 shows very schematically a side view of a second 3d-shaped hollow blade of a turbomachine according to the present invention,

FIG. 5A shows a tridimensional view from a lateral point of view of a twisted hollow blade of a turbomachine according to the present invention,

FIG. 5B shows the blade of FIG. 5A according to the same view and from the same point of view wherein only a set of cross-sections at different levels and the leading edge and the trailing edge have been considered, and

FIG. 5C shows a top view of the blade of FIG. 5A.

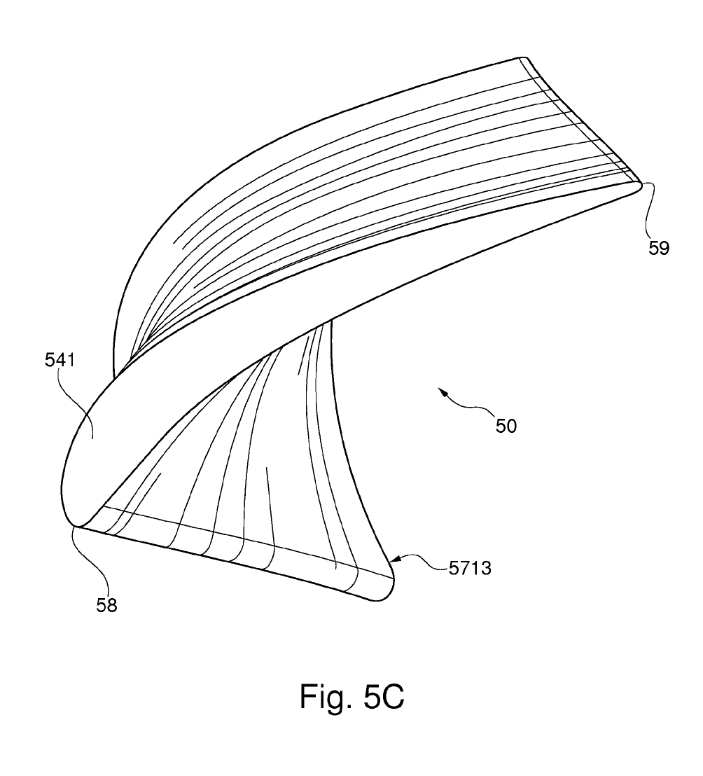

It is to be noted that FIG. 5A and FIG. 5B and FIG. 5C do not show the internal cavity of the blade for sake of legibility of the figures.

### DETAILED DESCRIPTION

The following description of exemplary embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

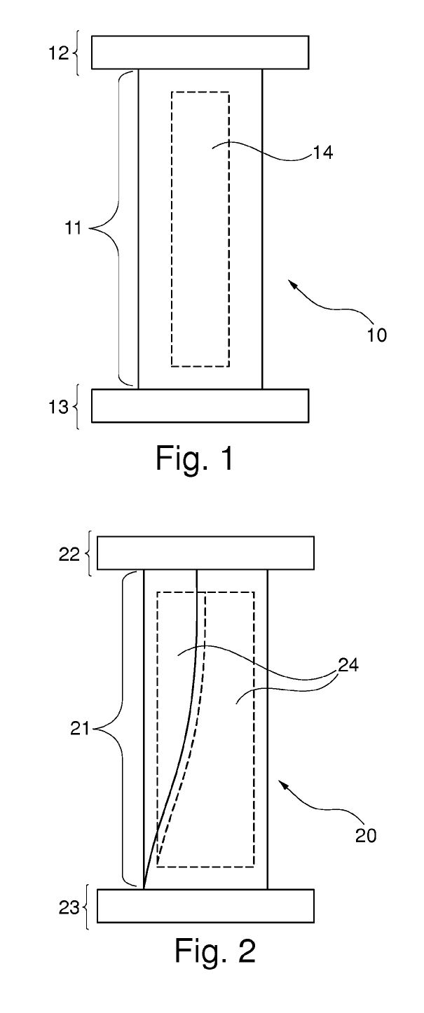

In FIG. 1 there is shown a turbomachine blade 10 comprising an airfoil portion 11, a (small) shroud portion 12 adjacent to a first end of the airfoil portion 11 and a (small) root portion 13 adjacent to a second end of the airfoil portion 11; a cavity 14 is internal to the airfoil portion 11 and extends along almost the entire length of the airfoil portion 11; cavity 14 is completely closed.

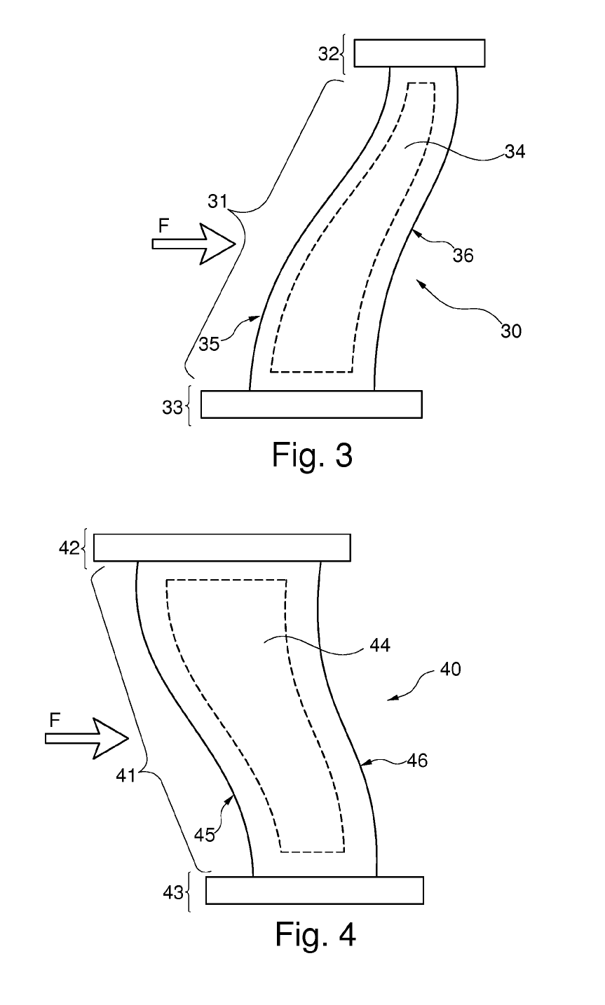

In FIG. 2 there is shown a turbomachine blade 20; such blade is particularly difficult to be manufactured at a reasonable cost; this embodiment will be used in the following for explain the present invention.

In general, a blade (20) of a turbomachine according to the present invention comprises an airfoil portion (21); the airfoil portion (21) extends longitudinally (for example from and first end adjacent to a root 23 to a second end adjacent to a shroud 22); the airfoil portion (21) is defined laterally by an external surface (also called “airfoil surface”); the airfoil portion (21) is 3D-shaped and has an internal cavity (24); the blade is in a single piece.

In general, by “3D-shaped” it is meant a shape that does not have a cylindrical symmetry. More particularly, in the present case, it is meant a solid shape extending from a lower plane shape to an upper plane shape wherein the development of the solid shape from the lower plane shape to the upper plane shape is not linear.

In the embodiment of FIG. 2, the “3D-shaped” is due to the fact that the airfoil portion 21 is “twisted”.

In the embodiment of FIG. 2, the cavity 24 is internal to the airfoil portion 21 and extends along almost the entire length of the airfoil portion 21; cavity 24 is completely closed. More in general, according to the present invention, the airfoil internal cavity extends longitudinally along from at least 40% to 100% of the entire length of the airfoil portion.

The internal cavity 24 has a solid shape (very) similar to the solid shape of the airfoil portion 21; therefore, in this embodiment, cavity 24 is also “twisted”.

The “twisted” character of the airfoil portion and of the internal cavity is only schematically shown in FIG. 2.

In the embodiment of FIG. 2, blade 20 comprises further a root portion 22 and/or a shroud portion 23.

According to the present invention, the airfoil portion and/or the airfoil internal cavity may be twisted, as for the embodiment of FIG. 2.

In the most general case a 3D-shaped twisted airfoil is a swept surface generated by moving and adjusting an airfoil section along two guide curves that typically define the leading edge and the trailing edge of the resulting airfoil. Acting on the guide curves, the generating airfoil section can be rotated and scaled along the span-wise direction yielding very complex three-dimensional (i.e. 3D) shapes, but keeping the continuity and tangency requirements of a smooth aerodynamic surface.

According to the present invention, the turbomachine blade is typically designed for a rotor or stator array; the rotor or stator defines a radial direction and an axial direction; the external surface of the airfoil portion has both a leading edge and a trailing edge.

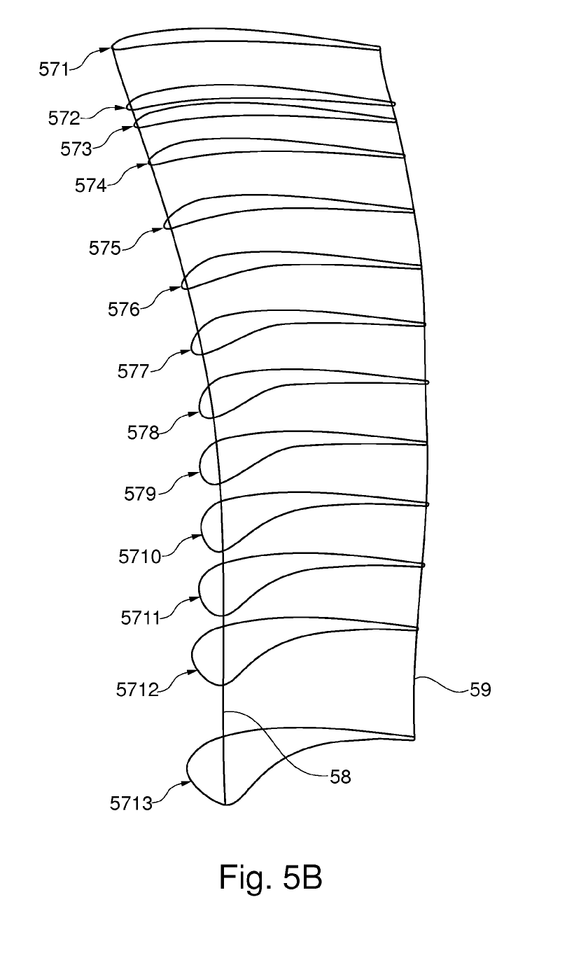

According to the present invention, the leading edge may shift backward in the axial direction moving in the radial direction (see FIG. 4).

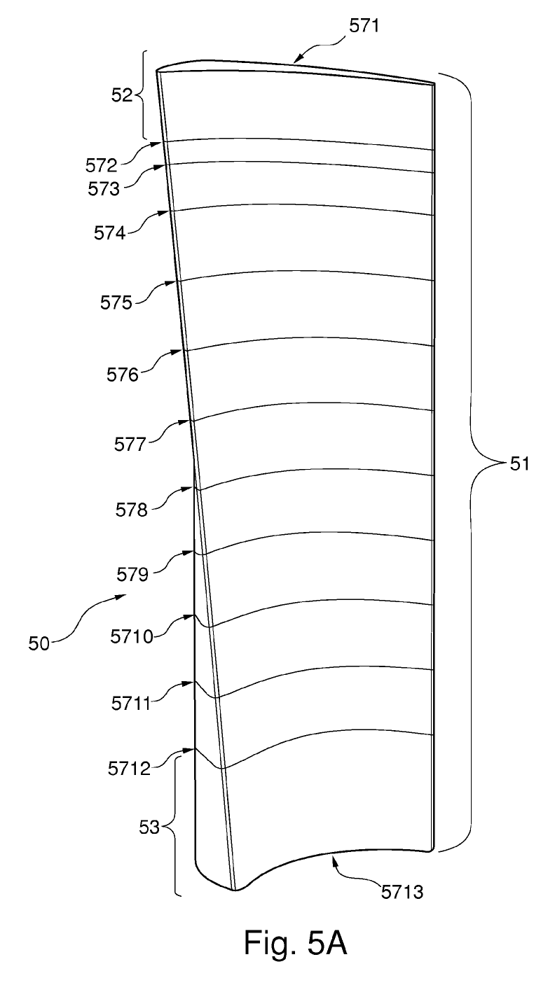

According to the present invention, the leading edge may shift forward in the axial direction moving in the radial direction (see FIG. 3).

According to the present invention, the trailing edge may shift backward in the axial direction moving in the radial direction (see FIG. 4).

According to the present invention, the trailing edge may shift forward in the axial direction moving in the radial direction (see FIG. 3).

Therefore, there are many possibilities including those wherein the leading edge or the trailing edge does not shift.

The words “forward” and “backward” refer to the direction of flow of the fluid around the airfoil portion when the turbomachine is in an operating state; in FIG. 3 and FIG. 4, the flow direction is indicated by an arrow labeled “F”.

In FIG. 3 and FIG. 4, numerical references similar to those of FIG. 1 and Fig, 2 are used; additionally, 35 and 45 are the leading edges and 36 and 46 are the trailing edges.

In the embodiments of FIG. 3 and FIG. 4, the airfoil internal cavity has a solid shape (very) similar to the solid shape of the airfoil portion; therefore, the “forward and/or backward shift” properties apply not only to the solid shape of the airfoil portion but also to the solid shape of the airfoil internal cavity.

In the embodiments of FIG. 2, FIG. 3 and FIG. 4, the internal cavity extends along substantially the whole longitudinal length of the airfoil portion, with the exception of very short portions, i.e. a layer of material, adjacent to the root and the shroud and that close the internal cavity at the ends of the airfoil portion.

It is to be noted that, according to the present invention, one or more of the “forward and/or backward shift” properties and the “twisted” property may also be combined.

According to specific embodiments of the present invention, the airfoil portion may have one or more channels extending from the external surface to at least one internal airfoil cavity; these channels are typically holes or slots.

According to specific embodiments of the present invention, the at least one internal cavity of the airfoil portion may extend into a root portion and/or a shroud portion of the blade, i.e. may be in communication with other internal external cavities.

As it will be more clear in the following, due to the fact that the realistic manufacturing methods of the blades according to the present invention are based on additive manufacturing, at least two holes (even very small) are associated to each internal cavity in order to evacuate the powder that remains in the cavity after the additive process is completed if the airfoil internal cavity is completely closed.

The blade 50 of the embodiment of FIG. 5, consists only of an airfoil portion 51; reference 52 corresponds to a first end of the airfoil portion 51 that will be adjacent to a shroud portion; reference 53 corresponds to a second end of the airfoil portion 51 that will be adjacent to a root portion; the solid shape of the airfoil portion 51 extends from a lower plane shape 5713 (in the end 53) to an upper plane shape 571 (in the end 52).

In FIG. 5A and FIG. 5B, a plurality of intermediate plane shapes 572, 573, 574, 575, 576, 577, 579, 579, 5710, 5711, 5712 are shown corresponding to the cross-sections of the airfoil portion 51 at different levels; in FIG. 5B and FIG. 5C, also the leading edge 58 and the trailing edge 59 are shown.

From these figures it is possible to see both the shifts and the rotation of the plane shape; additionally the plane shape changes its shape moving from the lower end of the airfoil portion to the upper end of the airfoil portion.

In FIG. 5, the airfoil internal cavity is not shown, but is conceptually similar to the internal cavity of FIG. 2 and it has a solid shape geometrically similar to the solid shape of the airfoil portion.

It is to be noted that, thanks to the use of additive manufacturing, the thicknesses may be very small; for example, the maximum thickness of the blade may be less than 10 mm (see for example FIG. 5C), the thickness of the trailing edge may be less than 2 mm (see for example FIG. 5C), the thickness of the wall adjacent to a internal cavity may be less than 2 mm and even less than 1 mm.

As already said, blades as defined above are designed and manufactured for being used in turbomachine, in particular in a rotor or stator array of a turbomachine stage, for “Oil & Gas” applications. The most typical applications are for steam turbines, more particularly as stator blades. In the case of stator blades of steam turbines the internal cavity or cavities is typically used for sucking condensation fluid or for ejecting hot fluid; in the case of rotor blades of steam turbines the internal cavity or cavities is typically used for lightening the blade; in case of stator blades of gas turbine assemblies (turbine section of the turbine assembly) the internal cavity or cavities is typically used for cooling the blade; in case of rotor blades of gas turbine assemblies (turbine section of the turbine assembly) the internal cavity or cavities is typically used for cooling and lightening the blade. It is possible that different functions may be combined in a single blade through different internal cavities.

The blade design according to the present invention may be used as (static or moving) phase separator device for a turbomachine (e.g. a steam turbine, a gas turbine, a compressor, a pump) that gets in contact with a multiphase fluid, typically a combination of liquid and gas.

It is to be noted that the holes or slots may be used for sucking condensation and, alternatively, for ejecting a fluid, typically a hot fluid.

It is to be noted that the internal cavities of the blade (if there is more than one) may be more than one and may have the same function or different functions (lightening the blade, cooling the blade, heating the blade, sucking fluid, ejecting fluid).

Blades as defined above (i.e. hollow, in particular with a longitudinal internal cavity, 3D-shaped, in particular “twisted” and/or “shifted”) are very difficult (if not impossible) to be manufactured using standard manufacturing methods, at least at a reasonable cost and with a reasonable quality.

The method of manufacturing a hollow 3D-shaped turbomachine blade in a single piece according to the present invention uses additive manufacturing. In particular, a single additive manufacturing process is used at least for its hollow 3D-shaped airfoil portion even if it is the internal cavity is completely closed or almost completely closed.

According to an embodiment, if the blade comprises a root portion and/or a shroud portion integral with the airfoil portion (i.e. in a single piece), a single additive manufacturing process is used for the whole blade.

No other manufacturing process is necessary apart from some finishing to the external surface of the blade.

As already said, according to the present invention, the turbomachine blade is typically designed for a rotor or stator array; the rotor or stator defines a radial direction and an axial direction.

The additive manufacturing may proceed at least partially according to the radial direction.

The additive manufacturing may proceed at least partially inclinedly to the radial direction.

In any case, the additive manufacturing proceeds typically according to a fixed angle with respect to the radial direction.

The additive manufacturing may use binding granular material or materials; in particular, the granular material or one of the granular materials or each of the granular materials is typically metallic.

Such manufacturing method is for manufacturing the blades according to the present inventions, in particular blades having cavities and/or projections identical or similar to the blades of FIGS. 1 and 2 and 3 and 4 and 5.

Additive manufacturing has many advantages with respect to the traditional technologies used for turbomachines blades, in particular for stator blades of steam turbines, as it allows a great design flexibility for the external shape of the blade as well as for the internal shape of the blade (in particular its internal cavity or cavities), as it allows to realize even small details in a shape (this includes the production of small blades), as it allows to realize graded materials in a blade (for example the material may vary along the length or height of a blade according to the mechanical and/or chemical requirements of the various specific points of the blade), as it allows a simpler manufacturing process and a lower manufacturing cost.

As far as manufacturing is concerned, it must be considered that in the field of “Oil & Gas” small-lot production is common also because solutions are studied (or at least customized) for a specific client. In general, it is always desirable to have a high precision and a low production cost.

What is claimed is:

1. A turbomachine blade, the turbomachine blade comprising:
an airfoil portion, wherein the airfoil portion extends longitudinally, is defined laterally by an external surface, has a 3D and twisted shape, and has an internal cavity,
wherein the turbomachine blade is in a single piece and is designed for a rotor or stator array, wherein the rotor or stator array defines a radial direction and an axial direction, wherein the external surface of the airfoil portion comprises a leading edge and a trailing edge, wherein the leading edge or the trailing edge shifts backward or forward in the axial direction moving in the radial direction, wherein the internal cavity extends along substantially the whole longitudinal length of the airfoil portion.

2. The turbomachine blade of claim 1, wherein the cavity has a 3D and a twisted shape or shifted shape.

3. The turbomachine blade of claim 1, wherein the leading edge shifts backward and the trailing edge shifts backward in the axial direction moving in the radial direction.

4. The turbomachine blade of claim 1, wherein the leading edge shifts forward and the trailing edge shifts forward in the axial direction moving in the radial direction.

5. The turbomachine blade of claim 1, integrating a root portion or a shroud portion adjacent to the airfoil portion, wherein the cavity is completely closed.

6. The turbomachine blade of claim 1, wherein the turbomachine blade has a thickness less than 10 mm.

7. The turbomachine blade of claim 1, wherein the turbomachine blade has a trailing edge thickness less than 2 mm.

8. The turbomachine blade of claim 1, wherein the turbomachine blade has a wall thickness less than 2 mm.

9. A turbomachine, comprising:
a plurality of blades arranged as a rotor or stator array of a turbomachine stage, wherein at least one of the plurality of blades comprises:
an airfoil portion, wherein the airfoil portion extends longitudinally, is defined laterally by an external surface, has a 3D and twisted shape, and has an internal cavity,
wherein the at least one blade is in a single piece, wherein the rotor or stator array defines a radial direction and an axial direction, wherein the external surface of the airfoil portion comprises a leading edge and a trailing edge, wherein the leading edge or the trailing edge shifts backward or forward in the axial direction moving in the radial direction, wherein the internal cavity extends along substantially the whole longitudinal length of the airfoil portion.

10. A method of manufacturing a turbomachine blade, the method comprising:
using additive manufacturing to manufacture the turbomachine blade in a single piece, wherein the turbomachine blade comprises:
an airfoil portion, wherein the airfoil portion extends longitudinally, is defined laterally by an external surface, has a 3D and twisted shape, and has an internal cavity,
wherein the turbomachine blade is designed for a rotor or stator array, wherein the rotor or stator array defines a radial direction and an axial direction, wherein the external surface of the airfoil portion comprises a leading edge and a trailing edge, wherein the leading edge or the trailing edge shifts backward or forward in the axial direction moving in the radial direction, wherein the internal cavity extends along substantially the whole longitudinal length of the airfoil portion.

11. The method of claim 10, wherein the additive manufacturing proceeds at least partially according to the radial direction.

12. The method of claim 10 further comprising binding granular metallic material or materials.

13. The method of claim 10, the method consisting in a single additive manufacturing process at least for the airfoil portion and excluding any other manufacturing process.

14. The turbomachine blade of claim 1, wherein the turbomachine blade has a wall thickness less than 1 mm.

15. The turbomachine blade of claim 2, wherein the leading edge shifts backward and the trailing edge shifts backward in the axial direction moving in the radial direction.

16. The turbomachine blade of claim 15, wherein the leading edge shifts forward and the trailing edge shifts forward in the axial direction moving in the radial direction.

17. The turbomachine blade of claim 16, integrating a root portion or a shroud portion adjacent to the airfoil portion, wherein the cavity is completely closed.

18. The turbomachine blade of claim 17, wherein the turbomachine blade has a thickness less than 10 mm.

19. The turbomachine blade of claim 2, wherein the leading edge shifts forward and the trailing edge shifts forward in the axial direction moving in the radial direction.

20. The turbomachine blade of claim 2, integrating a root portion or a shroud portion adjacent to the airfoil portion, wherein the cavity is completely closed.
